(19) United States
(12) Patent Application Publication
(10) Pub. No.: US 2009/0166199 A1
(43) Pub. Date: Jul. 2, 2009

(54) SENSOR AND METHOD FOR PRODUCING THE SENSOR

(76) Inventors: Yasuhiro Fujita, Kaizu (JP); Tetsuma Shimozato, Nagoya-shi (JP); Yoshiaki Matsubara, Nagoya-shi (JP)

Correspondence Address: STITES & HARBISON PLLC, 1199 NORTH FAIRFAX STREET, SUITE 900, ALEXANDRIA, VA, 22314, US

(21) Appl. No.: 12/345,024

(22) Filed: Dec. 29, 2008

(30) Foreign Application Priority Data
Dec. 28, 2007 (JP) P2007-340698

(51) Int. Cl. H01M 4/00; H01G 9/04

(52) U.S. Cl. 204/421; 29/25.03

(57) ABSTRACT

A sensor includes: a detection element including an internal electrode and an external electrode; an electrode terminal member; and a support member. The electrode terminal member includes: a base end portion supported by the support member; an electrode contact portion contacting the internal electrode or the external electrode; and a connection portion having a rear end connected to the base end portion and a front end connected to the electrode contact portion. A distance between the front end of the connection portion and the base end portion in a state where the electrode terminal member is assembled with the support member and separated from the detection element is equal to a distance between the front end of the connection portion and the base end portion in a state where the electrode terminal member is assembled with the detection element and the support member.

### CROSS-REFERENCE TO RELATED APPLICATIONS

This application is based on and claims priority to Japanese patent Application No. 2007-340698 filed Dec. 28, 2007, the above application incorporated herein by reference in its entirety.

### BACKGROUND OF THE INVENTION

1. Field of the Invention

The present invention relates to a sensor and method for producing the sensor, the sensor including: a detection element having a cylindrical shape with its front end closed and including an internal electrode formed on an internal surface thereof and an external electrode formed on an external surface thereof; an electrode terminal member contacting the internal electrode or the external electrode; and a support member supporting the electrode terminal member.

2. Description of Related Art

JP-A-2005-291907 describes a sensor. The sensor includes: a detection element extending along an axial direction and formed into a bottomed cylindrical shape having its front end closed and including an internal electrode formed on an internal surface thereof and an external electrode formed on an external surface thereof, to thereby detect a component to be measured; an electrode terminal member electrically connected to the internal electrode or the external electrode of the detection element; and a support member (a separator) supporting the electrode terminal member.

The electrode terminal member includes an internal electrode terminal member (in JP-A-2005-291907, a terminal member 30), which is connected to the internal electrode, and an external electrode terminal member (in JP-A-2005-291907, a connection member 40 for an external electrode layer) which is connected to the external electrode.

The internal electrode terminal member (in JP-A-2005-291907, a terminal member 30) includes an internal base end portion (in JP-A-2005-291907, a connector portion 31) which is supported by the support member, an internal electrode contact portion (in JP-A-2005-291907, an insertion portion 33) which contacts the internal electrode of the detection element, and an internal connection portion (separator insertion portion 32) having a rear end connected to the internal base end portion and a front end connected to the internal electrode contact portion (in JP-A-2005-291907, FIG. 3 or the like).

The internal electrode contact portion is reduced in a dimension (a dimension of a section perpendicular to the axial direction) by elastic deformation and disposed in the detection element. The internal base end portion is connected to a lead wire and supported by the support member.

The external electrode terminal member (in JP-A-2005-291907, a connection member 40 for an external electrode layer) includes an external base end portion which is supported by the support member, an external electrode contact portion that contacts the external electrode of the detection element, and an external connection portion having a rear end connected to the external base end portion and a front end connected to the external electrode contact portion (in JP-A-2005-291907, FIG. 2 or the like).

The external electrode contact portion is expanded in a dimension (a dimension of a section perpendicular to the axial direction) by elastic deformation and disposed in the detection element. The external base end portion is connected to a lead wire and supported by the support member.

However, in this sensor, assembling of the electrode terminal member (the internal electrode terminal member and the external electrode terminal member) with the detection element and the support member is complicated by the shape of the electrode terminal member (the internal electrode terminal member and the external electrode terminal member).

FIG. 6 is a side view showing an external electrode terminal member 108 as an example of a related-art electrode terminal member. FIG. 7 is a side view showing an internal electrode terminal member 109 as an example of a related-art electrode terminal member. In FIGS. 6 and 7, in addition to the electrode terminal member, a detection element 2 and a separator 7 are also shown in sectional view.

As shown in FIG. 6, in a state where the external electrode terminal member 108 is assembled with the support member and before the external electrode terminal member 108 is assembled with the detection element (free state), an external electrode contact portion 182 and an external base end portion 184 are spaced away from each other by a dimension D5. That is, in the free state, the dimension D5 is set for disposing the external electrode terminal member 108 such that a center axis S5 of the external electrode contact portion 182 overlaps (i.e., is aligned with) a center axis S3 of the detection element 2, and the external base end portion 184 is supported by the support member (a separator 7).

When the external electrode terminal member 108 is assembled with the detection element 2, the external electrode contact portion 182 is elastically deformed to radially expand such that the diameter L5 of the external electrode contact portion 182 is set to a dimension corresponding to the external diameter L4 of the detection element 2. Accordingly, the external electrode terminal member 108 can be assembled with the detection element 2.

In the free state, the internal electrode terminal member 109 shown in FIG. 7 is disposed such that the internal electrode contact portion 192 and the internal base end portion 194 are spaced away from each other by a dimension D6. That is, in the free state, the dimension D6 is set for disposing the internal electrode terminal member 109 such that a center axis S6 of the internal electrode contact portion 192 overlaps the center axis S3 of the detection element 2, and the internal base end portion 194 is supported by the support member (the separator 7).

When the internal electrode terminal member 109 is assembled with the detection element 2, the internal electrode contact portion 192 is elastically deformed to radially reduce such that the diameter L6 of the internal electrode contact portion 192 is equal to the internal diameter L3 of the detection element 2. Accordingly, the internal electrode terminal member 109 can be assembled with the detection element 2.

In a state where the external electrode terminal member 108 and the internal electrode terminal member 109 are assembled with the detection element 2 and the support member (assembled state), a distance between the electrode contact portion (a front end of the connection portion) and the base end portion is regulated by the detection element 2 and the support member. That is, in the assembled state, the distance between the front end of the connection portion and the base end portion is different from the distance in the free state (a distance set by the dimension D5 or the dimension D6).

FIG. 8A-FIG. 8C are explanatory views schematically showing the sections of the external electrode contact portion 182 of the external electrode terminal member 108, the internal electrode contact portion 192 of the internal electrode terminal member 109, and the detection element 2. FIG. 8A shows the members before being assembled. FIG. 8B shows the members before being assembled in an overlap manner. FIG. 8C shows a state after being assembled.

When the external electrode terminal member 108 is assembled with the detection element 2, the external electrode contact portion 182 is elastically deformed. In the deformation, a back portion B5 in the section of the external electrode contact portion 182 corresponding to a portion of the external electrode contact portion 182 connected to the external connection portion 186 (the section of a surface perpendicular to the axis) becomes a base point of the deformation.

Similarly, when the internal electrode terminal member 109 is assembled with the detection element 2, the internal electrode contact portion 192 is elastically deformed. In this deformation, a back portion B6 in the section of the internal electrode contact portion 192 corresponding to a portion of the internal electrode contact portion 192 connected to the internal connection portion 196 (the section of a surface perpendicular to the axis) becomes a base point of the deformation.

In this case, the external electrode terminal member 108 in the free state is disposed such that the center axis S5 thereof overlaps (i.e., is aligned with) the center axis S3 of the detection element 2. For this reason, the back portion B5 as the base point overlaps the detection element 2 (see FIG. 8B). The back portion B5 is a place at which elastic deformation of the external electrode contact portion 182 is most difficult to be generated (difficult to be widened). Accordingly, when the external electrode terminal member 108 is assembled with the detection element 2, a front end surface of the external electrode contact portion 182 is likely to meet with and collide against a rear end portion of the detection element 2. As a result, when the external electrode terminal member 108 is assembled to the detection element 2, the detection element 2 may be damaged due to collision at the back portion B5.

The internal electrode terminal member 109 in the free state is disposed such that the center axis S6 thereof overlaps the center axis S3 of the detection element 2. For this reason, the back portion B6 as the base point overlaps the detection element 2 (see FIG. 8B). The back portion B6 is a place at which the internal electrode contact portion 192 is most difficult to be elastically deformed (difficult to be reduced). Accordingly, when the internal electrode terminal member 109 is assembled with the detection element 2, a front end surface of the internal electrode contact portion 192 is likely to meet with and collide against a rear end portion of the detection element 2. As a result, when the internal electrode terminal member 109 is assembled to the detection element 2, the detection element 2 may be damaged due to collision at the back portion B6.

### BRIEF SUMMARY OF THE INVENTION

The present invention was made in consideration of the above circumstances, and an object thereof is to provide a sensor that can prevent damage to the detection element during assembly, and facilitate assembling the electrode terminal member with the detection element and the support member.

According to a first aspect, the present invention provides a sensor comprising: a detection element for detecting a component to be measured, an electrode terminal member, and a support member. The detection element comprises: a solid electrolyte body, an internal electrode, and an external electrode. The solid electrolyte body has a front end, a rear end, and a cylindrical shape with the front end closed, and defines an axial direction. The internal electrode is formed on an internal surface of the solid electrolyte body. The external electrode is formed on an external surface of the solid electrolyte body. The electrode terminal member is electrically connected to one of the internal electrode and the external electrode of the detection element. The support member supports the electrode terminal member. The electrode terminal member comprises: a base end portion supported by the support member; an electrode contact portion contacting the internal electrode or the external electrode of the detection element; and a connection portion having a rear end thereof connected to the base end portion and a front end thereof connected to the electrode contact portion. The electrode contact portion is of a hollow shape, extends in the axial direction, and defines a slit extending from a front end thereof to a rear end thereof, the electrode contact portion being attached to the detection element by an elastic force generated due to a change in dimension of the slit such that the electrode contact portion contacts one of the internal electrode and the external electrode. A distance between the front end of the connection portion and the base end portion, in a state wherein the electrode terminal member is assembled with the support member and is separated from the detection element is equal to a distance between the front end of the connection portion and the base end portion in a state wherein the electrode terminal member is assembled with the detection element and the support member.

In the electrode terminal member provided in the sensor, in a free state (in a state where the electrode terminal member is assembled with the support member and before the electrode terminal member is assembled with the detection element) and an assembled state (in a state where the electrode terminal member is connected to the detection element and supported by the support member), the distance between the front end of the connection portion and the base end portion is equal.

Therefore, at least a portion of a front end surface of the electrode contact portion corresponding to a back portion to the connection portion does not overlap the detection element in the axial direction. That is, when the electrode terminal member is assembled with the detection element, a place which is most difficult to be elastically deformed in the electrode terminal member does not collide against the detection element.

In other words, a place of the electrode terminal member, which is positioned around the slit and therefore most likely to be elastically deformed, collides against the detection element. Therefore, the electrode terminal member is easily deformed (widened or reduced) in accordance with the diameter of the detection element, and as a result, damage to the detection element can be prevented. Preferably, the slit is disposed opposite to the front end of the connection portion with respect to a center line of the solid electrolyte body.

Therefore, according to the first aspect of the invention, it is possible to realize a sensor that can prevent the damage to a detection element during assembly and facilitate assembling of an electrode terminal member with the detection element.

According to one implementation, the electrode terminal member comprises an internal electrode terminal member contacting the internal electrode. The internal electrode terminal member comprises an internal electrode contact portion, and the electrode contact portion comprises the internal electrode contact portion. At least a part of the internal electrode contact portion is disposed on the internal surface of the detection element and contacts the internal electrode. Accordingly, it is possible to prevent the detection element from being damaged by the internal electrode terminal member during assembly, and assembling of the electrode terminal member in the detection element can be performed easily.

According to another implementation, the electrode terminal member comprises an external electrode terminal member contacting the external electrode. The external electrode terminal member comprises an external electrode contact portion, and the electrode contact portion comprises the external electrode contact portion. At least a part of the external electrode contact portion is disposed on the external surface of the detection element and contacts the external electrode. Accordingly, it is possible to prevent the detection element from being damaged by the external electrode terminal member during assembly, and assembling of the electrode terminal member in the detection element can be performed easily.

The sensor may include the internal electrode terminal member and the external electrode terminal member each serving as the electrode terminal member. Therefore, the detection element can be further prevented from being damaged during assembly, and assembling of the individual members can be performed easily.

According to yet another implementation, the sensor further comprises: an internal electrode terminal member contacting the internal electrode; and an external electrode terminal member contacting the external electrode. The electrode terminal member comprises the internal electrode terminal member and the external electrode terminal member. The internal electrode terminal member comprises: an internal connection portion serving as the connection portion; and an internal electrode contact portion serving as the electrode contact portion, wherein at least a part of the internal electrode contact portion is disposed on the internal surface of the detection element and contacts the internal electrode. The external electrode terminal member comprises: an external connection portion serving as the connection portion; and an external electrode contact portion serving as the electrode contact portion, wherein at least a part of the external electrode contact portion is disposed on the external surface of the detection element and contacts the external electrode, wherein the external electrode contact portion is disposed so as to encompass the internal electrode contact portion. The internal connection portion is not located between the external connection portion and a center axis of the detection element when viewed along the axial direction.

When a sensor includes an internal electrode terminal member and an external electrode terminal member, and an external electrode contact portion is disposed so as to encompass an internal electrode contact portion, the external electrode contact portion and the internal electrode contact portion may be assembled by a series of assembling. In this case, in a state where the detection element is fixed by one of the external electrode contact portion and the internal electrode contact portion, the other electrode contact portion needs to be assembled with the detection element.

The sensor having the above configuration is configured such that, when viewed from the axial direction, the internal connection portion is disposed at a position which does not overlap the imaginary line (a line connecting the external connection portion and the center axis of the detection element). In this case, if the contact portion is elastically deformed, the relative position of the internal connection portion and the external connection portion may be changed. For this reason, in a front end surface of at least one of the internal electrode terminal member and the external electrode terminal member, at least a portion corresponding to a back portion to the connection portion is likely to collide against the detection element. As a result, the detection element may be damaged.

Even under these circumstances, the external electrode terminal member and the internal electrode terminal member according to this implementation, the damage to the detection element can be prevented when assembling (in particular, a series of assembling), and assembling of the electrode terminal member in the detection element can be performed easily.

According to another aspect, the present invention provides a method for producing a sensor. The sensor comprises: a detection element for detecting a component to be measured, an electrode terminal member, and a support member. The detection element comprises: a solid electrolyte body, an internal electrode, and an external electrode. The solid electrolyte body has a front end, a rear end, and a cylindrical shape with the front end closed, and defines an axial direction. The internal electrode is formed on an internal surface of the solid electrolyte body. The external electrode is formed on an external surface of the solid electrolyte body. The electrode terminal member is electrically connected to one of the internal electrode and the external electrode of the detection element. The support member supports the electrode terminal member. The electrode terminal member comprises: a base end portion supported by the support member; an electrode contact portion contacting one of the internal electrode and the external electrode of the detection element; and a connection portion having a rear end connected to the base end portion and a front end connected to the electrode contact portion. The electrode contact portion is of a hollow shape, extends in the axial direction, and defines a slit extending from a front end thereof to a rear end thereof, the electrode contact portion being attached to the detection element by an elastic force generated due to a change in dimension of the slit such that the electrode contact portion contacts one of the internal electrode and the external electrode. The method comprises: assembling the electrode terminal member with the support member; and thereafter assembling the electrode terminal member with the detection element in a state where a distance between the front end of the connection portion and the base end portion is maintained constant.

Accordingly, at least a portion of a front end surface of the electrode contact portion corresponding to a back portion to the connection portion does not overlap the detection element. That is, in the method using the electrode terminal member, when the electrode terminal member is assembled with the detection element, a place which is most difficult to be elastically deformed does not collide against the detection element. In other words, a place of the electrode terminal member which is likely to be elastically deformed collides against the detection element. For this reason, the electrode terminal member is easily deformed (widened or reduced) in accordance with the diameter of the detection element. As a result, damage to the detection element can be prevented.

Therefore, the sensor according to the above-described aspects of the invention prevents damage to a detection element during assembly and facilitates assembly of an electrode terminal member to the detection element.

Other features and advantages of the invention will be set forth in, or apparent from, the detailed description of the exemplary embodiments of the invention found below.

### BRIEF DESCRIPTION OF THE DRAWINGS

FIG. 1 is a side sectional view showing the overall configuration of a sensor (oxygen sensor) according to an exemplary embodiment of the invention;

FIG. 2 is a side sectional view of an external electrode terminal member, a separator, and a detection element;

FIG. 3 is a side sectional view of an internal electrode terminal member, a separator, and a detection element;

FIG. 4 is a front elevational view of an internal electrode terminal member;

FIG. 5A is an explanatory view schematically showing a relationship between sections of a detection element, an abutting portion of an external electrode terminal member, and an internal abutting portion of an internal electrode terminal member;

FIG. 5B is an explanatory view schematically showing a superposition of the detection element, the abutting portion of the external electrode terminal member, and the internal abutting portion of an internal electrode terminal member before assembly;

FIG. 5C is an explanatory view schematically showing a superposition of the detection element, the abutting portion of the external electrode terminal member, and the internal abutting portion of an internal electrode terminal member after assembly;

FIG. 6 is a side sectional view of a prior-art internal electrode terminal member;

FIG. 7 is a side sectional view of a prior-art external electrode terminal member; and

FIG. 8A is an explanatory view schematically showing a relationship between sections of an external electrode contact portion of a prior-art external electrode terminal member, an internal electrode contact portion of a prior-art internal electrode terminal member, and a detection element;

FIG. 8B is an explanatory view schematically showing a superposition of the external electrode contact portion of the prior-art external electrode terminal member, the internal electrode contact portion of the prior-art internal electrode terminal member, and the detection element before assembly;

FIG. 8C is an explanatory view schematically showing a superposition of the external electrode contact portion of the prior-art external electrode terminal member, the internal electrode contact portion of the prior-art internal electrode terminal member, and the detection element after assembly.

### DETAILED DESCRIPTION OF EXEMPLARY EMBODIMENTS OF THE INVENTION

An exemplary embodiment of the present invention is described with reference to the drawings. However, the present invention should not be construed as being limited thereto.

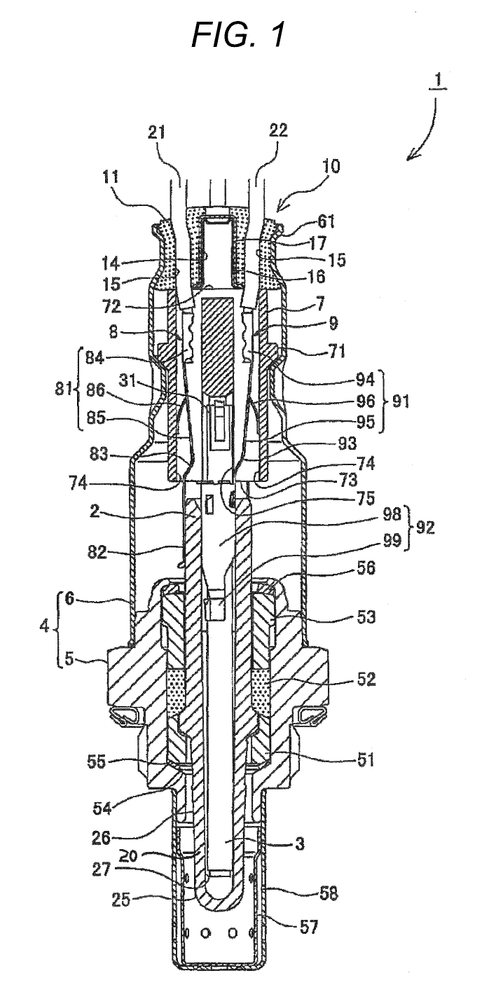

FIG. 1 is a side sectional view showing the overall configuration of a sensor (oxygen sensor 1) according to an embodiment of the invention.

In this embodiment, a lower end side of the oxygen sensor 1 shown in FIG. 1 corresponds to “a front end side of a sensor” and similarly, an upper end side of the oxygen sensor 1 shown in FIG. 1 corresponds to “a rear end side of a sensor”.

As shown in FIG. 1, the oxygen sensor 1 includes a detection element 2, a rod-shaped ceramic heater 3 that is disposed in the detection element 2 to heat the detection element 2, and a casing 4 that fixes the oxygen sensor 1 to a mount portion, such as an exhaust pipe. The detection element 2 includes a solid electrolyte body 20 primarily containing ZrO₂, which is formed into a bottomed cylindrical shape having its front end closed, an internal electrode 27 formed on an internal surface of the solid electrolyte body 20, and an external electrode 26 formed on an external surface of the solid electrolyte body 20.

The casing 4 includes a metal shell 5 that holds the detection element 2 which includes a detection portion 25 protruding inside the exhaust pipe, and an external cylinder 6 that is connected to an upper portion of the metal shell 5 and forms a reference gas space between the casing 4 and the detection element 2.

The metal shell 5 has a cylindrical main body. The metal shell accommodates a holder 51 supporting the detection element 2, and a sleeve 53 sandwiching a flange of the detection element 2 with the holder 51 via a filling member 52 made of talc powder.

A packing 55 is provided between a step portion 54 and a front end portion of the holder 51, and a packing 56 is provided on a rear end portion of the sleeve 53. An upper end portion of the metal shell 5 is crimped toward the step portion 54, and thus the filling member 52 is pressurized and filled. In this way, the detection element 2 is fixed to the metal shell 5. Metal protectors 57 and 58 forming a double-structured protector and each having a plurality of holes are welded to an external circumference on a lower end side of the metal shell 5 so as to cover the protrusion of the detection element 2.

After a lower opening end portion of the external cylinder 6 is inserted externally into the metal shell 5 so as to cover an upper opening of the metal shell 5, the lower opening end portion is welded externally. Thus, the external cylinder 6 is mounted in the metal shell 5.

A cylindrical insulating separator 7 made of ceramic is inserted internally in the vicinity of an upper opening 61 of the external cylinder 6.

The separator 7 has an outwardly protruding flange portion 71 on an external circumferential surface thereof in the vicinity of a center in the axial direction. When the external cylinder 6 is crimped externally, the separator 7 is held inside the external cylinder 6 in a state where a lower end surface of the flange portion 71 is engaged with an upper portion of the external cylinder 6.

The separator 7 includes a plurality of insertion holes 74 that pass through from a rear end surface 72 thereof toward a front end surface 73 thereof, and an opening 75 that is formed in the front end surface 73 so as to accommodate a rear end portion 31 of the ceramic heater 3. The separator 7 accommodates an external electrode terminal member 8 and an internal electrode terminal member 9 in different insertion holes 74, thereby maintaining electrical insulation between the external electrode terminal member 8 and the internal electrode terminal member 9, electrical insulation between the external electrode terminal member 8 and the external cylinder 6, and electrical insulation between the internal electrode terminal member 9 and the external cylinder 6.

The external electrode terminal member 8 is disposed so as to electrically connect an external electrode 26, which is disposed on an external circumferential surface of the detection element 2, and a lead wire 21. The internal electrode terminal member 9 is disposed so as to electrically connect an internal electrode 27, which is disposed on the internal circumferential surface of the detection element 2, and a lead wire 22.

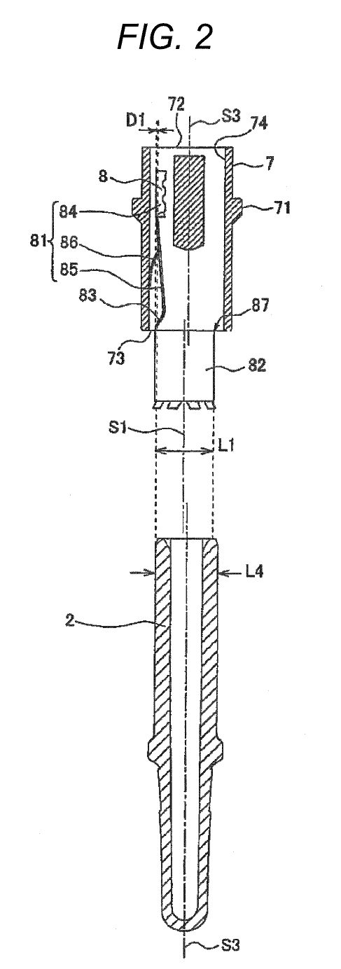

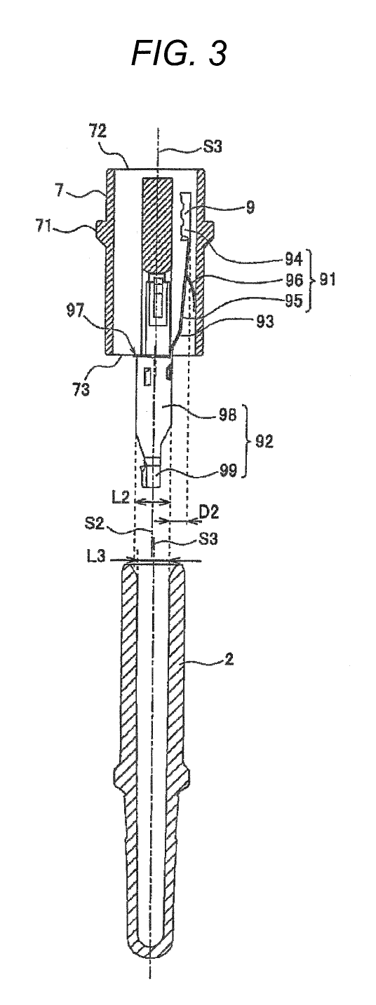

FIG. 2 is a side view of the external electrode terminal member 8, the separator 7, and the detection element 2. FIG. 3 is a side view of the internal electrode terminal member 9, the separator 7, and the detection element 2. In FIGS. 2 and 3, the detection element 2 and the separator 7 are shown in a sectional view in order to show the internal structure.

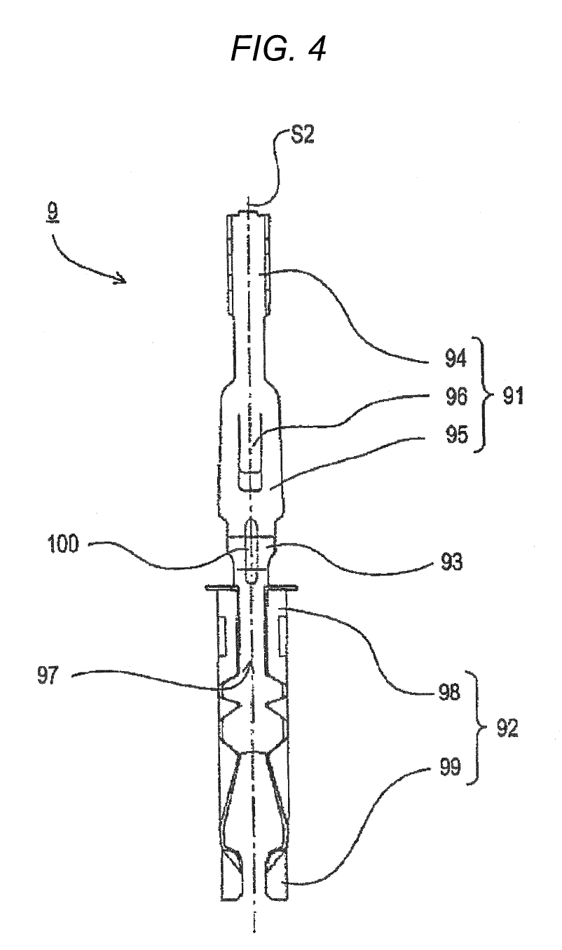

FIG. 4 is a front view of the internal electrode terminal member 9.

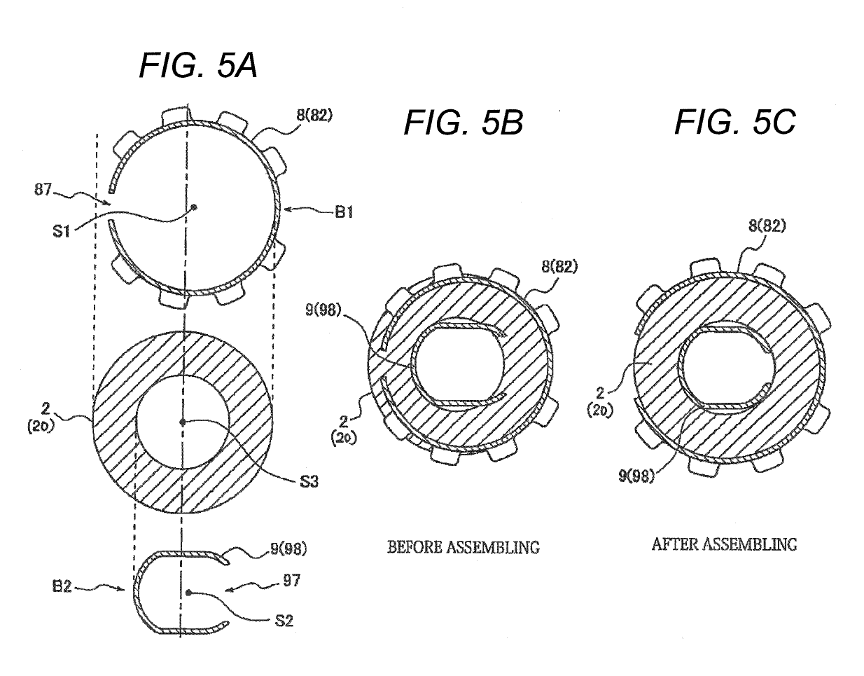

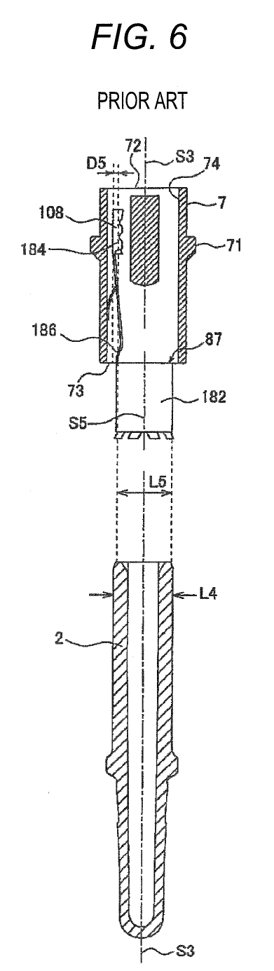

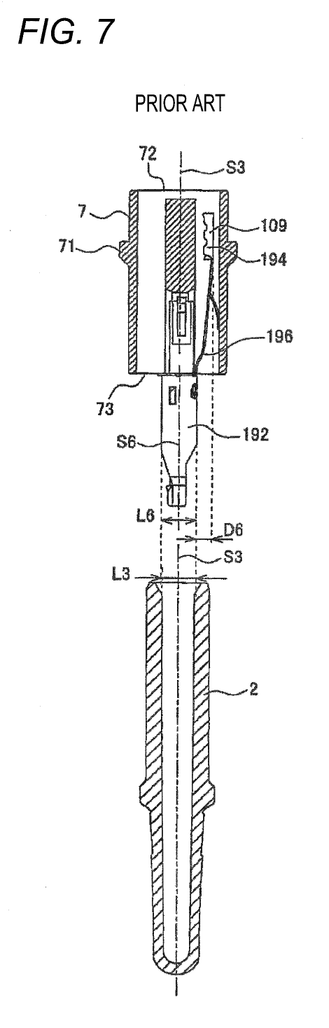

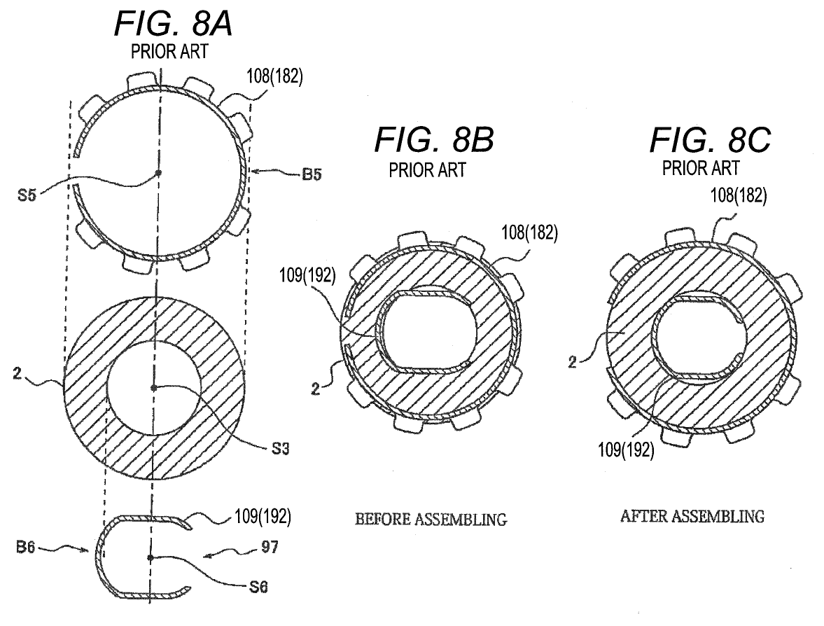

FIG. 5A-FIG. 5C are explanatory views schematically showing the sections of the detection element 2, an abutting portion 82 of the external electrode terminal member 8, and an internal abutting portion 98 of the internal electrode terminal member 9. FIG. 5A separately shows the members before being assembled. FIG. 5B shows the members before being assembled in an overlap manner. FIG. 5C shows a state after being assembled.

The external electrode terminal member 8 is formed of a single metal plate (for example, stainless steel plate). The external electrode terminal member 8 includes a base end portion 81 that is accommodated in the insertion hole 74 of the separator 7, an abutting portion 82 that contacts the external electrode 26, and a connection portion 83 that connects the base end portion 81 and the abutting portion 82.

The base end portion 81 includes a crimp portion 84 that crimps the front end of the lead wire 21 to electrically connect the lead wire 21 and the external electrode terminal member 8, a lead portion 85 that is led from the crimp portion 84 to the connection portion 83, and an external urging portion 86 that protrudes from the lead portion 85 so as to urge against the internal circumferential surface of the insertion hole 74.

The external electrode terminal member 8 is held inside the insertion hole 74 of the separator 7 when the lead portion 85 and the external urging portion 86 contacts the internal circumferential surface of the insertion hole 74. The lead portion 85 is configured such that both ends thereof in a width direction contact the internal circumferential surface of the insertion hole 74, while the connection portion 83 is separated from the internal circumferential surface of the insertion hole 74.

The abutting portion 82 has a hollow shape and has a slit portion 87 (see FIG. 5A) extending from a front end thereof to a rear end thereof. The abutting portion 82 is connected with the front end of the connection portion 83 at a position which is symmetric to the slit portion 87 with respect to a center axis S1 of the abutting portion 82. The abutting portion 82 is assembled with the detection element 2 by an elastic force to be generated due to a change in dimension of a gap of the slit portion 87, and contacts the external electrode 26.

That is, when the external electrode terminal member 8 is assembled with the detection element 2, the abutting portion 82 is elastically enlarged such that the diameter L1 of the abutting portion 82 is increased to a dimension corresponding to the external diameter L4 of the detection element 2. Thus, the external electrode terminal member 8 can be assembled with the detection element 2. In this case, the abutting portion 82 is elastically deformed. A back portion B1 (see FIG. 5A) becomes a base point of the elastic deformation. The back portion B1 is a portion in the section (the section of a plane perpendicular to the axis) of the abutting portion 82 which overlaps with a portion of the abutting portion 82 connected to the connection portion 83 as viewed from the axial direction.

The internal electrode terminal member 9 is formed of a single metal plate (for example, a stainless steel plate). The internal electrode terminal member 9 includes a base end portion 91 that is accommodated inside the insertion hole 74 of the separator 7, a detection element accommodating portion 92 that is accommodated in the detection element 2, and a connection portion 93 that connects the base end portion 91 and the detection element accommodating portion 92.

The base end portion 91 includes a crimp portion 94 that crimps the front end of the lead wire 22 to electrically connect the lead wire 22 and the internal electrode terminal member 9, a lead portion 95 that is led from the crimp portion 94 to the connection portion 93, and an internal urging portion 96 that protrudes from the lead portion 95 so as to urge against the internal circumferential surface of the insertion hole 74.

The internal electrode terminal member 9 is held inside the insertion hole 74 of the separator 7 when the lead portion 95 and the internal urging portion 96 contact the internal circumferential surface of the insertion hole 74. The lead portion 95 is configured such that both ends thereof in a width direction contact the internal circumferential surface of the insertion hole 74, while the connection portion 93 is separated from the internal circumferential surface of the insertion hole 74.

The detection element accommodating portion 92 includes an internal abutting portion 98 that contacts the internal electrode 27 to electrically connect the internal electrode terminal member 9 and the detection element 2, and a heater holding portion 99 that holds the ceramic heater 3.

As shown in FIG. 4, the internal abutting portion 98 has a hollow shape and includes a slit portion 97 extending from a front end thereof to a rear end thereof. The internal abutting portion 98 is connected with the front end of the connection portion 94 at a position opposite to the slit portion 97 with respect to a center axis S2 of the internal abutting portion 98. The internal abutting portion 98 is assembled with the detection element 2 by an elastic force to be generated due to a change in dimension of a gap of the slit portion 97, and contacts the internal electrode 27.

That is, when the internal electrode terminal member 9 is assembled with the detection element 2, the internal abutting portion 98 is elastically deformed such that the diameter L2 of the internal abutting portion 98 is reduced to a dimension corresponding to the internal diameter L3 of the detection element 2. Thus, the internal electrode terminal member 9 can be assembled with the detection element 2.

In this case, the internal abutting portion 98 is elastically deformed. A back portion B2 (see FIG. 5A) becomes a base point of the elastic deformation. The back portion B2 is a portion in the section (the section of a surface perpendicular to the axis) of the internal abutting portion 98 which overlaps with a portion of the internal abutting portion 98 connected to the connection portion 93 as viewed from the axial direction.

The connection portion 93 has a convex portion 100 formed on a surface thereof. The internal urging portion 96 is provided by cutting a central portion of the lead portion 95 and obliquely extending the cut piece downwardly.

Returning to FIG. 1, in the upper opening 61 of the external cylinder 6, the lead wires 21 and 22 are led outside so as to be individually connected to the electrodes of the detection element 2. A seal unit 10 is provided so as to prevent water or oil from entering inside of the oxygen sensor 1.

The seal unit 10 includes a cylindrical grommet 11 made of fluorine rubber, a cylindrical insertion member 16 that is able to be fitted and inserted into a through hole 14, which passes through the center of the grommet 11 along the axis, and a sheet aeration filter 17 that covers an upper end portion (atmosphere-side end portion) of the cylindrical insertion member 16, and is sandwiched and fixed between an internal circumferential surface of the through hole 14 of the grommet 11 and an external circumferential surface of the cylinder insertion member 16.

The grommet 11 has the through hole 14 and insertion holes 15, into which the lead wires 21 and 22 are inserted.

The aeration filter 17 is an aeration filter which has a porous fiber structure (for example, product name: Gore-Tex (Japan Gore-Tex, Inc.) obtained by expanding an unbaked mold product, such as polytetrafluoroethylene (PTFE), at a heating temperature higher than the melting point of PTFE in a uniaxial direction, thereby inhibiting transmission of a liquid based on water, such as water droplets and permitting transmission of gas (air, vapor, or the like).

When the grommet 11, the aeration filter 17, and the cylindrical insertion member 16 are assembled, the aeration filter 17 covers the cylindrical insertion member 16 so as to cover the atmosphere-side end portion and the external circumferential surface of the cylindrical insertion member 16, and is inserted into the through hole 14 in this state together with the cylindrical insertion member 16. In this way, the aeration filter 17 is sandwiched between the external circumferential surface of the cylindrical insertion member 16 and the internal circumferential surface of the through hole 14, and is fixed in a state where an aeration path is closed.

The seal unit 10 formed in the above-described manner is disposed inside the upper opening 61 of the external cylinder 6, and the grommet 11 is crimped radially through the external cylinder 6. In this way, the external cylinder 6 and the grommet 11 are close to each other, and sealing property is secured. Then, while aeration and waterproof properties are maintained by the aeration filter 17, air is introduced from the atmosphere into the reference gas space through the aeration path, which is formed inside the cylindrical insertion member 16.

In the manufacturing process of the oxygen sensor 1, the ceramic heater 3 is supported by the heater holding portion 99 of the detection element accommodating portion 92 in the internal electrode terminal member 9, and one end of the lead wire 22 is supported by the crimp portion 94 of the base end portion 91 in the internal electrode terminal member 9.

In the manufacturing process of the oxygen sensor 1, in a state where the rear end portion of the ceramic heater 3 is accommodated in the opening 75 of the separator 7, the lead wire 22 is inserted into the insertion hole 74 of the separator 7 from the front end surface 73 of the separator 7 toward the rear end surface 72 (hereinafter, referred to as a terminal member accommodating process).

With these processes, the base end portion 91 of the internal electrode terminal member 9 can be accommodated inside the insertion hole 74 of the separator 7.

The lead portion 95 and the internal urging portion 96 of the internal electrode terminal member 9 urge the internal circumferential surface of the insertion hole 74 of the separator 7, and thus the internal electrode terminal member 9 is held inside the insertion hole 74.

One of the characterized features of the oxygen sensor 1 is the external electrode terminal member 8 and the internal electrode terminal member 9.

The external electrode terminal member 8 is configured such that a distance (e.g., distance in a radial direction perpendicular to the axial direction) between the front end of the connection portion 83 and the base end portion 81 in the free state (in a state where the external electrode terminal member 8 is assembled with the separator 7 and before the external electrode terminal member 8 is assembled with the detection element 2, in other words, in a state where the electrode terminal member 8 is assembled with the separator 7 and separated from the detection element 2) is identical to a distance between the front end of the connection portion 83 and the base end portion 81 in the assembled state of the oxygen sensor 1 (in a state where the external electrode terminal member 8 is assembled with the detection element 2 and the separator 7). Specifically, as shown in FIG. 2, in the free state, the external electrode terminal member 8 is configured such that the front end of the connection portion 83 and the base end portion 81 are spaced away from each other by a dimension D1.

In other words, the assembled state of the oxygen sensor 1 means a state where the external electrode terminal member 8 is assembled with the detection element 2, the casing 4, the separator 7, and the like.

The internal electrode terminal member 9 is configured such that a distance (e.g. a distance in the radial direction) between the front end of the connection portion 93 and the base end portion 91 in the free state (in a state where the internal electrode terminal member 9 is assembled with the separator 7 and before the internal electrode terminal member 9 is assembled with the detection element 2, in other words, in a state where the internal electrode terminal member is assembled with the separator 7 and separated from the detection element 2) is identical to a distance between the front end of the connection portion 93 and the base end portion 91 in the assembled state of the oxygen sensor 1 (in a state where the internal electrode terminal member 9 is assembled with the detection element 2 and the separator 7). Specifically, as shown in FIG. 3, in the free state, the internal electrode terminal member 9 is configured such that the front end of the connection portion 93 and the base end portion 91 are spaced away from each other by a dimension D2.

In other words, the assembled state of the oxygen sensor 1 means a state where the internal electrode terminal member 9 is assembled with the detection element 2, the casing 4, the separator 7, and the like.

As shown in FIGS. 5A-5C, with respect to the external electrode terminal member 8 in the free state, in a state where the base end portion 81 (the crimp portion 84) is disposed in the insertion hole 74 of the separator 7, a portion of an internal surface of the abutting portion 82 corresponding to a back portion to the connection portion 83 is disposed at a position corresponding to the external circumferential surface of the detection element 2 (see FIG. 5B).

From this point, when the external electrode terminal member 8 in the free state is assembled with the detection element 2, a portion of the front end surface of the abutting portion 82 corresponding to a back portion to the connection portion 83 can be disposed so as not to overlap the detection element 2. That is, with the external electrode terminal member 8 of this embodiment, when the external electrode terminal member 8 is assembled with the detection element 2, a place of the external electrode terminal member 8 which is most difficult to be elastically deformed (a portion of the front end surface of the abutting portion 82 corresponding to a back portion to the connection portion 83) can be prevented from colliding against the detection element 2.

With respect to the internal electrode terminal member 9 in the free state, in a state where the base end portion 91 (the crimp portion 94) is disposed in the insertion hole 74 of the separator 7, a portion of the external surface of the internal abutting portion 98 corresponding to a back portion to the connection portion 93 is disposed at a position corresponding to the internal circumferential surface of the detection element 2 (see FIG. 5B).

From this point, when the internal electrode terminal member 9 in the free state is assembled with the detection element 2, a portion of the front end surface of the detection element accommodating portion 92 (the internal abutting portion 98) corresponding to a back portion to the connection portion 93 can be disposed so as not to overlap the detection element 2. That is, with the internal electrode terminal member 9 of this embodiment, when the internal electrode terminal member 9 is assembled with the detection element 2, a place of the internal electrode terminal member 9 which is most difficult to be elastically deformed (a portion of the front end surface of the internal abutting portion 98 corresponding to a back portion to the connection portion 93) can be prevented from colliding against the detection element 2.

As described above, in the oxygen sensor 1 of this embodiment, the assembling is performed while the relative positions among the detection element 2, the separator 7, and the external cylinder 6 are kept unchanged from that in the sensor assembled state. As a result, the detection element 2 can be prevented from being damaged.

In the oxygen sensor 1 of this embodiment, in order to prevent the detection element 2 from being damaged when assembling, it is not necessary to maintain a distance between the members (the detection element, the electrode terminal member, the support member, and the like) in accordance with a special position relation different from that in the sensor assembled state. That is, it should suffice if the distance in a state where the sensor is completed is maintained, and thus the complexity of assembling can be reduced.

Therefore, according to the oxygen sensor 1 of this embodiment, the detection element 2 can be prevented from being damaged when assembling, and the complexity of assembling of the electrode terminal member (the external electrode terminal member 8 and the internal electrode terminal member 9) in the detection element 2 can be reduced.

In the oxygen sensor 1 of this embodiment, the position relation of the connection portion 93 in the internal electrode terminal member 9 and the connection portion 83 in the external electrode terminal member 8 is symmetric with respect to the center axis S3 of the detection element 2. Likewise, the position relation of the slit portion 97 and the slit portion 87 is symmetric with respect to the center axis S3 of the detection element 2. With this configuration, the oxygen sensor 1 can prevent the connection portion 93 of the internal electrode terminal member 9 from interfering with the connection portion 83 of the external electrode terminal member 8 in the internal space of the oxygen sensor 1.

In this embodiment, the oxygen sensor 1 is an example of a sensor, each of the external electrode terminal member 8 and the internal electrode terminal member 9 is an example of an electrode terminal member, and the casing 4 (the metal shell 5 and the external cylinder 6) and the separator 7 are an example of a support member.

In the external electrode terminal member 8, the base end portion 81 is an example of a base end portion, the abutting portion 82 is an example of an electrode contact portion, and the connection portion 83 is an example of a connection portion. In the internal electrode terminal member 9, the base end portion 91 is an example of a base end portion, the detection element accommodating portion 92 (the internal abutting portion 98) is an example of an electrode contact portion, and the connection portion 93 is an example of a connection portion. The abutting portion 82 is an example of an external electrode contact portion, and the internal abutting portion 98 is an example of an internal electrode contact portion.

An embodiment of the invention has been described above, but the invention is not limited to the foregoing embodiment. Various changes and modifications can be made without departing from the technical scope of the invention.

For example, the invention is not limited to the oxygen sensor, but may be applied to a gas sensor detecting other gas components (CO, NOx, or the like) or a temperature sensor for temperature detection insofar as it includes an electrode terminal member.

In the sensor assembled state, the position relation of the connection portion of the internal electrode terminal member and the connection portion of the external electrode terminal member may not be symmetric with respect to the center axis of the detection element. It should suffice if the internal electrode terminal member and the external electrode terminal member do not interfere with each other in the internal space of the sensor.

In the foregoing embodiment, although the electrode terminal member being made of a single metal plate has been described, the electrode terminal member is not limited to a single metal plate. For example, a plurality of metal members may be used in combination.

The electrode terminal member is not limited to one made of a stainless steel plate. For example, other metal materials may be used insofar as they exhibit conductivity.

In the external electrode terminal member 8 of the foregoing embodiment, the relative position relation of the back portion and the slit portion in the abutting portion 82 is symmetric with respect to the center axis S1 of the external electrode terminal member 8. However, the relative position relation of the back portion and the slit portion in the abutting portion is not limited thereto. Other relative position relations may be used.

What is claimed is:

1. A sensor comprising:
a detection element for detecting a component to be measured, the detection element comprising: a solid electrolyte body having a front end, a rear end, and a cylindrical shape with the front end closed, and defining an axial direction; an internal electrode formed on an internal surface of the solid electrolyte body; and an external electrode formed on an external surface of the solid electrolyte body;
an electrode terminal member electrically connected to one of the internal electrode and the external electrode of the detection element; and
a support member supporting the electrode terminal member,
the electrode terminal member comprising: a base end portion supported by the support member; an electrode contact portion contacting at least one of the internal electrode and the external electrode of the detection element; and a connection portion having a rear end connected to the base end portion and a front end connected to the electrode contact portion,
the electrode contact portion being of a hollow shape extending in the axial direction, and defining a slit extending from a front end thereof to a rear end thereof, the electrode contact portion being attached to the detection element by an elastic force generated due to a change in dimension of the slit such that the electrode contact portion contacts one of the internal electrode and the external electrode, and
a distance between the front end of the connection portion and the base end portion, in a state wherein the electrode terminal member is assembled with the support member and is separated from the detection element, being equal to a distance between the front end of the connection portion and the base end portion in a state wherein the electrode terminal member is assembled with the detection element and the support member.

2. The sensor according to claim 1,
wherein the electrode terminal member comprises an internal electrode terminal member contacting the internal electrode,
wherein the internal electrode terminal member comprises an internal electrode contact portion, and wherein the electrode contact portion comprises the internal electrode contact portion, and
wherein at least a part of the internal electrode contact portion is disposed on the internal surface of the detection element and contacts the internal electrode.

3. The sensor according to claim 1,
wherein the electrode terminal member comprises an external electrode terminal member contacting the external electrode,
wherein the external electrode terminal member comprises an external electrode contact portion, and wherein the electrode contact portion comprises the external electrode contact portion, and
wherein at least a part of the external electrode contact portion is disposed on the external surface of the detection element and contacts the external electrode.

4. The sensor according to claim 1,
further comprising: an internal electrode terminal member contacting the internal electrode; and an external electrode terminal member contacting the external electrode, the electrode terminal member comprising the internal electrode terminal member and the external electrode terminal member,
the internal electrode terminal member comprising: an internal connection portion serving as the connection portion; and an internal electrode contact portion serving as the electrode contact portion, at least a part of the internal electrode contact portion being disposed on the internal surface of the detection element and contacting the internal electrode,
the external electrode terminal member comprising: an external connection portion serving as the connection portion; and an external electrode contact portion serving as the electrode contact portion, at least a part of the external electrode contact portion being disposed on the external surface of the detection element and contacting the external electrode, the external electrode contact portion encompassing the internal electrode contact portion, and
the internal connection portion being not located between the external connection portion and a center axis of the detection element when viewed along the axial direction.

5. A method for producing a sensor,
said sensor comprising:
a detection element for detecting a component to be measured, the detection element comprising: a solid electrolyte body having a front end, a rear end, and a cylindrical shape with the front end closed, and defining an axial direction; an internal electrode formed on an internal surface of the solid electrolyte body; and an external electrode formed on an external surface of the solid electrolyte body;
an electrode terminal member electrically connected to one of the internal electrode and the external electrode of the detection element; and
a support member supporting the electrode terminal member,
the electrode terminal member comprising: a base end portion supported by the support member; an electrode contact portion contacting at least one of the internal electrode and the external electrode of the detection element; and a connection portion having a rear end connected to the base end portion and a front end connected to the electrode contact portion, and
the electrode contact portion being of a hollow shape, extending in the axial direction, and defining a slit extending from a front end thereof to a rear end thereof, the electrode contact portion being attached to the detection element by an elastic force generated due to a change in dimension of the slit such that the electrode contact portion contacts one of the internal electrode and the external electrode,
said method comprising:
assembling the electrode terminal member with the support member; and
thereafter assembling the electrode terminal member with the detection element in a state where a distance between the front end of the connection portion and the base end portion is maintained constant.
